(19) United States
(12) Patent Application Publication
(10) Pub. No.: US 2010/0228646 A1
(43) Pub. Date: Sep. 9, 2010

(54) Integration of scanner/sensor apparatuses, web-based interfaces, and pull-supply chain management into product, clothing, apparel, shoe, and/or accessory markets

(76) Inventor: Robert Eric Heidel, Oak Ridge, TN (US)

Correspondence Address: Robert Eric Heidel, 896 West Outer Drive, Oak Ridge, TN, 37830, US

(21) Appl. No.: 12/660,810

(22) Filed: Mar. 4, 2010

Related U.S. Application Data
(60) Provisional application No. 61/209,306, filed on Mar. 5, 2009.

(51) Int. Cl. G06Q 30/00; G06Q 50/00; G06Q 20/00; G06Q 10/00; G06F 3/048; G06T 15/00; G06F 17/30; G06F 3/01

(52) U.S. Cl. 705/27; 705/310; 715/757; 345/419; 707/705; 707/E17.001; 715/760

(57) ABSTRACT

The patent pertains to an embodiment of an invention and/or process for scanning a person's, object's, and/or animal's body and/or physical disposition using a scanner/sensor apparatus to generate measurements and/or avatars comprised of exact, specific, and/or unique body measurements, physical dispositions, and/or spatial requirements within three dimensional and 360 degree space. Once the avatars are generated, stored to a database and/or memory device and uploaded to a Web-based interface, consumers will be able to purchase products, clothing, apparel, shoes, and/or accessories across varying lines, brands, styles, and trends that are manufactured to their exact body measurements. Businesses and/or commercial entities will have the ability to create digital images of their subsequent lines, brands, styles, and trends of products, clothing, apparel, shoes, and/or accessories and upload them to a Web-based interface. Businesses and/or commercial entities will also be able to advertise their abilities to market; manufacture, and sell varying lines, brands, styles, and trends of their products, clothing apparel, shoes, and/or accessories to consumers. Finally, businesses and/or commercial entities will be able to utilize pull-supply chain management as a result of utilization of the invention and/or process.

### CROSS-REFERENCE TO RELATED APPLICATION

U.S. Provisional Application No. 61/209,306, Integration of scanner/sensor apparatuses, Web-based interfaces, and pull-supply chain management into product, clothing, apparel, shoe, and/or accessory markets

### FEDERALLY SPONSORED RESEARCH

None

### SEQUENCE LISTING

None

### BACKGROUND OF INVENTION

1. Field of Invention

This invention pertains to the integration of scanner/sensor apparatuses, Web-based interfaces, and pull-supply chain management into product, clothing, apparel, shoe, and/or accessory markets. Consumers will be able to purchase products, clothing, apparel, shoes, and/or accessories via Web-based interfaces that are manufactured to their exact, specific, and/or unique body measurements, physical dispositions, and/or spatial requirements after said exact measurements, dispositions, and/or requirements are generated in three dimensional and 360 degree space using a scanner/sensor apparatus.

2. Discussion of Prior Art

Retailers, wholesalers, and other sorts of businesses and commercial entities have been selling products, clothing, apparel, shoes, and/or accessories to consumers for many years. Something inherent in this kind of business is high overhead and production costs associated with manufacturing many different sizes, models, makes, dimensions, lines, styles, trends, and designs of products, clothing, apparel, shoes, and/or accessories and also the costs of stocking said goods (i.e. stock-out costs), tracking retail flow, and the plethora of other costs associated with this kind of business model.

The traditional business model for product, clothing, apparel, shoe, and/or accessories stores was designed to attract customers through prices, sales, advertising, location, and marketing and having consumers physically enter a store and browse through available stock and purchase goods in a store. Then, businesses created catalogs where people could purchase and have goods delivered via mail to a desired destination. Later, the internet revolutionized the way the customers could pick and choose clothing, apparel, shoes, and/or accessories from Websites and Web-based interface by using a computer. The item was then shipped to a desired destination of the consumer's choosing.

Store, catalog, and internet consumers had to be aware of not knowing if the purchased good would fit their unique body measurements as well as not knowing the tangible quality of a good they had never seen or physically tried on. Businesses must take on the cost of manufacturing clothing, apparel, shoes, and/or accessories in many different sizes, shapes, lines, designs, styles, and trends to meet the spectrum of needs and wants of consumers in the marketplace. It is not guaranteed that all manufactured goods will be sold and therefore a business will be susceptible to unwanted costs associated with consumer supply and demand during the economic trend of that time.

Something else inherent in the business model is that many different lines, brands, styles, and trends of products, clothing, apparel, shoes, and/or accessories exist and do not all fit the same when it comes to a unique consumer's measurements. An item of clothing from one brand will be manufactured at a certain size, for example a Levi's pair of jeans with a 36 inch waist and 32 inch length, and a consumer will be able to fit into the jeans comfortably. However, the same consumer will purchase a pair of jeans of another brand, for example a Hollister pair of jeans with a 36 inch waist and 32 inch length, and the jeans will not fit at all. This type of inconsistency in regards to the manufacturing and sizing methods of varying lines, brands, styles, and/or trends of products, clothing, apparel, shoes, and/or accessories is a problem for businesses and/or commercial entities targeting existing and yet to be discovered consumer and demographic markets.

Scanning/sensor technology has been utilized in motion picture and video game markets for many years to capture the movement and exact, specific, and/or unique body measurements, physical dispositions, and/or spatial requirements of humans, animals, and/or objects in three dimensional and 360 degree space. Young-A Lee, an assistant professor in Apparel, Educational Studies and Hospitality Management at Iowa State University, has done extensive research with the utilization of 3D body scanners in obtaining body measurements for clothing and design purposes. [TC]² is a manufacturer of a 3D body scanner called the NX16 which is used for apparel, health/fitness/medical, entertainment/gaming, and virtual worlds. It is relatively the size of a changing room and generates hundreds of automatic measurements and an avatar of a person in a true-to-scale three dimensional body model.

3. Objects and Advantages

Accordingly, the integration of scanner/sensor apparatuses, Web-based interfaces, and pull-supply chain management into product, clothing, apparel, shoe, and accessory markets has many advantages over past processes and these include:

(a) Consumers will be able to purchase products, clothing, apparel, shoes, and/or accessories manufactured to their exact, specific, and/or unique body measurements, physical dispositions, and/or spatial requirements
(b) Consumers will be able to purchase products, clothing, apparel, shoes, and/or accessories across varying lines, brands, styles, and/or trends that will fit their exact, specific, and/or unique body measurements, physical dispositions, and/or spatial requirements
(c) Manufacturers, retailers, wholesalers, businesses, and/or commercial entities will be able to utilize a pull-supply chain management system for purposes of manufacturing, marketing, advertising, and/or selling existing and yet to be discovered lines, brands, styles, and/or trends of products, clothing, apparel, shoes, and/or accessories
(d) Businesses and/or commercial entities in consumer product, clothing, apparel, shoe, and/or accessory markets will be able to reduce business costs associated with stocking goods and items in stores through the use of a Web-based interface
(e) The utilization of scanner/sensor technology in product, clothing, apparel, shoe, and/or accessory markets will provide the consumer with a service that improves the chances of successful purchases of products, clothing, apparel, shoes, and/or accessories manufactured to the consumer's exact, specific, and/or unique body measurements, physical dispositions, and/or spatial requirements
(f) The utilization of scanner/sensor technology in product, clothing, apparel, shoe, and/or accessory markets will provide businesses and/or commercial entities with consumer data and information that can be used to manufacture products, clothing, apparel, shoes, and/or accessories according to consumer's exact, specific, and/or unique body measurements, physical dispositions, and/or spatial requirements
(g) Businesses and/or commercial entities will be able to advertise to consumer and demographic markets their ability to manufacture and sell their subsequent lines, brands, styles, and/or trends of products, clothing, apparel, shoes, and/or accessories to consumers based off of the consumers' generated exact, specific, and/or unique body measurements, physical dispositions, and/or spatial requirements

### SUMMARY

The present invention pertains to an embodiment of a process for a scanner/sensor apparatus that can generate a consumer's exact body measurements in three dimensional and 360 degree space and store the generated measurements to a database system and/or memory device. The process will allow for a consumer to purchase existing and yet to be discovered lines, brands, styles, and trends of a businesses' and/or commercial entities' products, clothing, apparel, shoes, and/or accessories that can be manufactured to reflect exact, specific, and/or unique body measurements, physical dispositions, and/or spatial requirements of consumers using a Web-based interface. The process will allow for manufacturers, retailers, wholesalers, businesses, and/or commercial entities to reduce overhead costs associated with stocking pieces of products, clothing, apparel, shoes and/or accessories through “pull” supply chain management versus “push” supply chain management.

The scanner/sensor apparatus can be implemented into any existing or yet to be discovered business and/or commercial entity that sells products, clothing, apparel, shoes, and/or accessories to consumers. A consumer will have their body scanned using a scanner/sensor apparatus to generate the consumer's measurements in three dimensional and 360 degree space to create an avatar comprised of exact, specific, and/or unique body measurements, physical dispositions, and/or spatial requirements and said data will be saved to a database system and/or memory device. The measurements can then be used by the consumer to purchase products, clothing, apparel, shoes, and/or accessories manufactured according to the specifications of the generated measurements.

Consumers will either upload their measurements and/or avatar comprised of exact, specific, and/or unique body measurements, physical dispositions, and/or spatial requirements to a Web-based interface or allow businesses and/or commercial entities to access a database containing their measurements. The Web-based interface will contain “Point and Click” applications that allow consumers to pick and choose from any number of existing or yet to be discovered lines, brands, styles, and trends of products, clothing, apparel, shoes, and/or accessories. Businesses and/or commercial entities will upload pictures of said lines, brands, styles, and trends of products, clothing, apparel, shoes, and/or accessories to the interface so that consumers will be able to see what is being sold, marketed, and manufactured by said subsequent businesses and/or commercial entities. The consumer will purchase products, clothing, apparel, shoes, and/or accessories using applications within the Web-based interface and the products, clothing, apparel, shoes, and/or accessories will be manufactured to match the uploaded and/or accessed exact, specific, and/or unique body measurements, physical dispositions, and/or spatial requirements generated by the scanner/sensor apparatus. The products, clothing, apparel, shoes, and/or accessories will then be shipped to the consumer and/or a desired location.

### BRIEF DESCRIPTION OF THE DRAWINGS

FIG. 1. This figure is a flowchart of an embodiment of an example of a scanner/sensor apparatus, a database system and/or memory device, their manufacture, their purchase, and then their installation and/or implementation into a business and/or commercial entity.

FIG. 2. This figure is a flowchart of an embodiment of an example of consumers paying to have their body dimensions and/or physical dispositions scanned using a scanner/sensor apparatus to generate an avatar comprising their exact, specific, and/or unique body measurements, physical dispositions, and/or spatial requirements scanned within three dimensional and 360 degree space.

FIG. 3. This figure is a flowchart of an embodiment of an example of consumers' measurements and/or avatars comprised of exact, specific, and/or unique body measurements, physical dispositions, and/or spatial requirements within three dimensional and 360 degree space generated by a scanner/sensor apparatus being saved to a database system and/or memory device.

FIG. 4. This figure is a flowchart of an embodiment of an example of consumers uploading measurements and/or avatars comprised of exact, specific, and/or unique body measurements, physical dispositions, and/or spatial requirements within three dimensional and 360 degree space from a memory device to a Web-based interface and purchasing products, clothing, apparel, shoes, and/or accessories from a business and/or commercial entity through said Web-based interface.

FIG. 5. This figure is a flowchart of an embodiment of an example showing how a business and/or commercial entity could access a database system and/or memory device for consumers' measurements and/or avatars comprised of exact, specific, and/or unique body measurements, physical dispositions, and/or spatial requirements within three dimensional and 360 degree space once consumers have purchased products, clothing, apparel, shoes, and/or accessory via the Web-based interface.

FIG. 6. This figure is a flowchart of an embodiment of an example of a business and/or commercial entity using the uploaded or accessed measurements and/or avatars comprised of exact, specific, and/or unique body measurements, physical dispositions, and/or spatial requirements within three dimensional and 360 degree space from a database system or memory device to manufacture products, clothing, apparel, shoes, and/or accessory according to said measurements and consumers being mailed and/or shipped the new product, clothing, apparel, shoes, and/or accessory after purchase and manufacture.

FIG. 7. This figure is a flowchart of an embodiment of an example of consumers' new ability to purchase a product, piece of clothing, piece of apparel, shoes, and/or accessory and have said product, piece of clothing, piece of apparel, shoes, and/or accessory manufactured across existing and yet to be discovered lines, brands, styles, and/or trends to the consumers' measurements and/or avatars comprised of exact, specific, and/or unique body measurements, physical dispositions, and/or spatial requirements within three dimensional and 360 degree space generated by the scanner/sensor apparatus.

FIG. 8. This figure is a flowchart of an embodiment of an example of how businesses and/or commercial entities can pay to access consumers' measurements that are stored to a database and/or memory device for purposes of advertising the businesses' and/or commercial entities' ability to manufacture existing and yet to be discovered lines, brands, styles, and trends of said businesses' and/or commercial entities' products, clothing, apparel, shoes, and/or accessories to the measurements and/or avatars comprised of exact, specific, and/or unique body measurements, physical dispositions, and/or spatial requirements within three dimensional and 360 degree space of consumers generated by the scanner/sensor apparatus.

FIG. 9. This figure is a flowchart of an embodiment of an example of how consumers can pay to have their measurements and/or avatars comprised of exact, specific, and/or unique body measurements, physical dispositions, and/or spatial requirements within three dimensional and 360 degree space generated by a scanner/sensor apparatus and saved to a database system and/or memory device many times over the course of their life and physical development as well as when life events occur for purposes of purchasing varying lines, brands, styles, and/or trends of products, clothing, apparel, shoes, and/or accessories.

FIG. 10. This figure is a flowchart of an embodiment of an example of how the scanner/sensor apparatus and database system and/or memory device can be modified in their basic utilization and design to generate measurements and/or avatars comprised of exact, specific, and/or unique body measurements, physical dispositions, and/or spatial requirements within three dimensional and 360 degree space for different body parts and/or physical dispositions of a humans, animals, and/or objects according to the needs and/or specializations of businesses and/or commercial entities and consumers.

FIG. 11. This figure is a flowchart of an embodiment of an example of how consumers will be able to utilize a Web-based interface to purchase products, clothing, apparel, shoes, and/or accessories from all existing or yet to be discovered businesses and/or commercial entities. The figure shows how a consumer will upload measurements and/or avatars comprised of exact, specific, and/or unique body measurements, physical dispositions, and/or spatial requirements within three dimensional and 360 degree space generated by a scanner/sensor apparatus from a database system and/or memory device to a Web-based interface and then search said Web-based interface for varying lines, brands, styles, and trends of businesses' and/or commercial entities' products, clothing, apparel, shoes, and/or accessories and make a purchase.

FIG. 12. This figure is a flowchart of an embodiment of an example of how consumers will search for varying lines, brands, styles, and trends of businesses' and/or commercial entities' products, clothing, apparel, shoes, and/or accessories via a Web-based interface and make purchases. A business and/or commercial entity that had been purchased from would then access a database system and/or memory device that contains consumers' measurements and/or avatars comprised of exact, specific, and/or unique body measurements, physical dispositions, and/or spatial requirements within three dimensional and 360 degree space for means of manufacturing the purchased product, clothing, apparel, shoes, and/or accessory.

FIG. 13. This figure is a flowchart of an embodiment of an example of how Web-based interfaces will contain “point and click” applications that allow for consumers to pick and choose between all existing and yet to be discovered lines, brands, styles, and trends of businesses' and/or commercial entities' products, clothing, apparel, shoes, and/or accessories and make purchases.

FIG. 14. This figure is a flowchart of an embodiment of an example of businesses and/or commercial entities uploading images of the products, clothing, apparel, shoes, and/or accessories that are sold and manufactured by said businesses and/or commercial entities to a Web-based interface. Businesses and/or commercial entities will upload the images to a Web-based interface and consumers will be able to use “point and click” applications within the Web-based interface that will link them to the uploaded images and allow consumers to conduct purchases and/or monetary and/or credit transactions for said businesses' and/or commercial entities' products, clothing, apparel, shoes, and/or accessories.

### DRAWINGS

### List of Reference Numerals

101—Scanner/sensor apparatus
102—Database system and/or memory device
103—Manufacture (of a scanner/sensor apparatus and a database system and/or memory device)
104—Purchase (of a scanner/sensor apparatus and a database system and/or memory device)
105—Installation and/or Implementation (of a scanner/sensor apparatus and a database system and/or memory device)
106—Business and/or commercial entity
201—Consumers
202—Paying
203—Scan (of consumers' exact, specific, and/or unique body measurements, physical dispositions, and/or spatial requirements)
204—Avatars comprised of consumers' exact, specific, and/or unique body measurements, physical dispositions, and/or spatial requirements
301—Save (consumer's avatars comprised of their exact, specific, and/or unique body measurements, physical dispositions, and/or spatial requirements to a database system and/or memory device)
401—Upload (consumers' avatars comprised of their exact, specific, and/or unique body measurements, physical dispositions, and/or spatial requirements)
402—Web-based interface
403—Purchase (of products, clothing, apparel, shoes, and/or accessories)
404—Products, clothing, apparel, shoes, and/or accessories
405—Access (a database system and/or memory device)
501—Manufacture (of products, clothing, apparel, shoes, and/or accessories)
502—Mail and/or ship (products, clothing, apparel, shoes, and/or accessories to consumers)
601—Ability (to purchase products, clothing, apparel, shoes, and/or accessories across varying lines, brands, styles, and/or trends manufactured to consumers' exact measurements)
602—Lines (of products, clothing, apparel, shoes, and/or accessories)
603—Brands (of products, clothing, apparel, shoes, and/or accessories)
604—Styles (of products, clothing, apparel, shoes, and/or accessories)
605—Trends (of products, clothing, apparel, shoes, and/or accessories)
701—Pay (for access to a consumers' avatars comprised of their exact, specific, and/or unique body measurements, physical dispositions, and/or spatial requirements for purposes of advertising)
702—Advertise (ability to manufacture lines, brands, styles, and/or trends of products, clothing, apparel, shoes, and/or accessories to the consumers' avatars comprised of their exact, specific, and/or unique body measurements, physical dispositions, and/or spatial requirements)
703—Manufacture (varying lines, brands, styles, trends of businesses' and/or commercial entities' products, clothing, apparel, shoes, and/or accessories)
801—Course of life and physical development as well as life events
901—Modification (to the scanner/sensor apparatus and database system and/or memory device)
902—Different body parts and/or physical dispositions (of a human, object, and/or animal)
903—Human
904—Object
905—Animal
906—Needs and/or specializations (of a business and/or commercial entity for consumers)
907—Search (on a Web-based interface for products, clothing, apparel, shoes, and/or accessories)
908—“Point and Click” applications (within a Web-based interface)
909—Images (of products, clothing, apparel, shoes, and/or accessories)

### DETAILED DESCRIPTION

This non-provisional patent application pertains to an embodiment of an invention and/or process for scanning a person's, object's, and/or animal's body and/or physical disposition using a scanner/sensor apparatus to generate measurements and/or avatars comprised of exact, specific, and/or unique body measurements, physical dispositions, and/or spatial requirements within three dimensional and 360 degree space and storing the measurements to a database and/or memory device so that consumers can purchase products, clothing, apparel, shoes, and/or accessories manufactured to said person's, object's, and/or animal's unique body specifications or desires via a Web-based interface.

The scanner/sensor apparatus can be manufactured using any kind of design, process, specification, material, and/or technology that exists or yet has been discovered. The scanner/sensor apparatus could be designed to just generate measurements of all body parts where products, clothing apparel, shoes, and/or accessories can be worn and/or utilized. The design and utilization of the scanner/sensor apparatus can change according to the kind of business and/or commercial entity it is implemented into and/or the particular needs of the consumer, business, commercial entity, and/or the kind of product, clothing, apparel, shoe, and/or accessory being sold. The functionality of the scanner/sensor itself and the method of scanning a body and/or physical disposition can be of any known process, technology, design, and/or function of a scanner/sensor that exists or has yet to be discovered.

The design of the scanner/sensor apparatus can change to take measurements and/or avatars comprised of exact, specific, and/or unique body measurements, physical dispositions, and/or spatial requirements within three dimensional and 360 degree space of different body parts as needed. The scanner/sensor apparatus can be implemented into any kind of existing business and/or commercial entity for means of generating a person's, object's, and/or animal's measurements. The basic function of the scanner/sensor apparatus is to create measurements and/or avatars comprised of exact, specific, and/or unique body measurements, physical dispositions, and/or spatial requirements within three dimensional and 360 degree space to generate precise measurements of that person's, animal's, and/or object's physical disposition for purposes of selling products, clothing, apparel, shoes, and/or accessories that can be manufactured to said specific measurements.

A database and/or memory device will be created to store a consumer's measurements for access when purchases are made via a Web-based interface. The storage and/or saving of a consumer's measurements can be done by any process for storing and/or saving electronic information that exists or yet has been discovered. The measurements can be stored and/or saved as any file type that exists or has yet been discovered. The designated database and/or memory device where the measurements are stored can be of any design, software, hardware, size, specification, utilization, implementation, manufacture, brand, and/or business that exists or has yet to be discovered.

The consumer will either upload the generated measurements from a memory device to a Web-faced interface or a business and/or commercial entity will access a database where the consumer's measurements are stored. The Web-based interface will contain applications that allow for a consumer to purchase products, clothing, apparel, shoes, and/or accessories. Consumers will be able to upload measurements and/or avatars comprised of exact, specific, and/or unique body measurements, physical dispositions, and/or spatial requirements within three dimensional and 360 degree space to the Web-based interface using any kind of existing or yet to be discovered process that allows an entity to upload electronic data to a Web-based interface. Consumers will also be able to upload credit and/or monetary information to the Web-based interface using any kind of existing or yet to be discovered process that allows an entity to upload electronic data to a Web-based interface. Consumers will be able to make purchases on the Web-based interface using any kind of existing or yet to be discovered process that allows an entity to make purchases through secure monetary and/or credit transactions with a Web-based interface.

All information and data sent to and from the consumer and/or business and/or commercial entity within the Web-based interface can be done by any existing or yet to be discovered means by which information and data can be sent in a direct, secure, and electronic fashion between two parties by electronic business-to-business (B2B), business-to-consumer (B2C), and/or consumer-to-consumer (C2C) communications. In instances where sensitive personal, monetary, and/or credit information is being exchanged between parties, any form of electronic communications security system can be employed to create direct, secure, and electronic linkages needed between networks, servers, and/or computers of consumers, individuals, and/or businesses and/or commercial entities. The data and information sent via said linkages can be encrypted at a 32-bit, 64-bit, 128-bit, and/or any other encryption level to ensure secure and protected transmission of data between consumers, businesses, commercial entities, and/or any third parties.

The Website can be database-driven and can be written in an SQL style and/or any other kind of style that exists or has yet been discovered of programming language that is utilized for retrieving and managing data in relational database management system. Examples of database management systems include but are not limited to PostgreSQL, MySQL, DB2, and Oracle. Any type of database management system that exists or has yet been discovered can be utilized in the process. Users of the Web-based virtual marketplace interface will potentially need HTML interfaces, CGI form processing, JavaScript, PHP, and/or any other sort of program that exists or has yet been discovered to interact with the database through the Web-based virtual marketplace interface on the front end. For application scripting purposes, Python, Ruby, Perl, and/or any other existing or yet to be discovered program can be utilized to complete processing tasks that connect the Web-based virtual marketplace interface at the front end to the database at the back end.

The consumer will purchase varying lines, brands, styles, and trends of products, clothing, apparel, shoes, and/or accessories via the Web-based interface. The Web-based interface will have applications that allow a consumer to “point and click” on links that contain businesses' and/or commercial entities' products, clothing, apparel, shoes, and/or accessories. Businesses and/or commercial entities will upload images of the products, clothing, apparel, shoes, and/or accessories that they sell and manufacture to the Web-based interface so that consumers can visually pick and choose said items. The uploading of images of products, clothing, apparel, shoes, and/or accessories can be executed by any kind of existing or yet to be discovered process for uploading images to a Web-based interface.

Consumers will then be able to purchase products, clothing, apparel, shoes, and/or accessories by conducting a secure monetary and/or credit transaction with said business and/or commercial entity. The business and/or commercial entity will then access the customer's measurements and/or avatars comprised of exact, specific, and/or unique body measurements, physical dispositions, and/or spatial requirements within three dimensional and 360 degree space from the database system and/or uploaded information from the memory device and manufacture the purchased product, clothing, apparel, shoes, and/or accessories to the measurements generated by the scanning of the person's body. The file format for the measurements and/or avatars comprised of exact, specific, and/or unique body measurements, physical dispositions, and/or spatial requirements within three dimensional and 360 degree space for consumers can be in any existing or yet to be discovered format.

The manufacturing of the products, clothing, apparel, shoes, and/or accessories can be done by any process, technology, materials, and/or any other sort of manufacturing process that exists or has yet to been discovered. The process allows for utilization of “pull” supply chain management where businesses and/or commercial entities will manufacture varying lines, brands, styles, and/or trends of products, clothing, apparel, shoes, and/or accessories according to the unique measurements of consumers that are generated by the scanner/sensor apparatus.

Once a consumer has purchased products, clothing, apparel, shoes, and/or accessories via the Web-based interface, manufacturers will be able to “pull” all the necessary materials together through the supply stream. The process can be used by any kind of business associated with the procuring of materials, manufacturing, marketing, supply-chain management, advertising, managing, owning, and/or selling products, clothes, apparel, shoes, and/or accessories to consumers and/or any sort of business and/or commercial entity that exists or has yet to be discovered.

The scanner/sensor apparatus that scans a person's body can be implemented into any kind of business and/or commercial entity that is aforementioned above where consumers could complete the scanning process. Consumers may choose to have their measurements and/or avatars comprised of exact, specific, and/or unique body measurements, physical dispositions, and/or spatial requirements within three dimensional and 360 degree space taken at one store or any number of stores. A consumer will come to a location where the scanner/sensor apparatus is installed and have their body and/or body parts scanned to their own desire, need, and/or want. The consumer will pay to have the scanning done and the generated measurements and/or avatars comprised of exact, specific, and/or unique body measurements, physical dispositions, and/or spatial requirements within three dimensional and 360 degree space will be stored into a database and/or memory device where the consumer and any sort of business and/or commercial entity can access and/or upload the data to a Web-based interface for means of manufacturing a product, piece of clothing, apparel, shoes, and/or accessory that the consumer has chosen to purchase.

The accessing of a database that contains the consumer's measurements can be granted under the approval of the consumer and/or any business and/or commercial entity that has the consumer's measurements stored to a database. A consumer will allow a business and/or commercial entity to access the measurements that are stored to a database and/or memory device once a purchase has been made via the Web-based interface and manufacturing is about to be facilitated of said purchased item. A business and/or commercial entity can sell access to the generated measurements and/or avatars comprised of exact, specific, and/or unique body measurements, physical dispositions, and/or spatial requirements within three dimensional and 360 degree space stored to a database to businesses, commercial entities, and/or any third party that want access for means of advertising, selling, and/or manufacturing products, clothing, apparel, shoes, and/or accessories.

The business and/or commercial entity could require that the measurements generated by the scanner/sensor apparatus only be accessed within said businesses' and/or commercial entities' subsequent holdings, partners, acquisitions, and/or supply-chain management system. A business and/or commercial entity could strictly operate the scanner/sensor apparatus and then store the generated measurements to a database for future use and/or possibly sell the rights to a person's measurements to other businesses. The generated measurements could be wholly owned by the consumer if so desired. Consumers and businesses and/or commercial entities can decide the ownership and/or ability to access generated measurements as each see fit.

Once a consumer has uploaded measurements from a memory device to the Web-based interface or a consumer's measurements have been stored on a database, businesses and/or commercial entities can be provided with access to said measurements via the consent of the consumer, business, and/or commercial entity for purposes of advertising. A third party, business, and/or commercial entity can advertise their subsequent products, clothing, apparel, shoes, and/or accessories and their ability to manufacture said items to a consumer's specific measurements. Businesses and/or commercial entities can track the kinds of products, clothing, apparel, shoes, and/or accessories that consumers are purchasing and advertise strictly to certain consumer demographics that are purchasing said businesses' and/or commercial entities' lines, brands, styles, and trends of products, clothing, apparel, shoes, and/or accessories. Businesses and/or commercial entities can advertise products, clothing, apparel, shoes, and/or accessories and the ability to manufacture said products, clothing, apparel, shoes, and/or accessories within the Web-based interface or by various other existing and yet to be discovered electronic mediums.

The product, clothing, apparel, shoes, and/or accessory will be purchased by the consumer on a Web-based interface. The Web-based interface can be of any design and/or utility that exists or has yet been discovered. The purchase can be conducted using any kind of existing or yet to be discovered secure credit and/or monetary transfer that can be facilitated over the internet. The product, clothing, apparel, shoes, and/or accessory will then be manufactured to reflect the generated measurements and/or avatars comprised of exact, specific, and/or unique body measurements, physical dispositions, and/or spatial requirements within three dimensional and 360 degree space and then shipped to a desired destination of the consumer's choosing.

The kinds of products, clothing, apparel, shoes, and/or accessories that this invention pertains to but not limited to in terms of breadth and scope for selling, marketing, advertising, and manufacturing include shirts, t-shirts, underwear, boxers, undergarments, socks, lingerie, panties, bras, jackets, men's and women's suits, dresses, shoes, sandals, boots, uniforms, jeans, pants, shorts, slippers, pajamas, sweaters, tank-tops, earrings, watches, necklaces, rings, all existing and yet to be discovered forms of jewelry, piercings, headdresses, scarves, bracelets, protective devices (armor), socks, sportswear, hats, toboggans, sweatbands, headbands, wigs, prosthetic limbs, knee braces, neck braces, ankle braces, joint braces, girdles, thongs, “nighties,” sleepwear, robes, skirts, halter tops, blouses, dress shoes, work boots, protective eyewear, helmets, sunglasses, eyeglasses, reading glasses, ear muffs, Snuggies, coats, gloves, scarves, insulated underwear, scrubs, nylons, belts, back braces, panty hose, corsets, arm braces, wheelchairs, medical equipment, diabetic socks, support hose, jogging suits, sweat suits, gowns, house coats, wedding dresses, tuxedoes, formal wear, prom dresses, Halloween costumes, costumes, collars, cuff links, religious apparel, “skins” for electronic devices, training bras, sports bras, hospital gowns, lab jacket, lab coat, maternity clothes, TED hose, crutches, walkers, hospital beds, home medical equipment, bed pans, toilets, handicap devices, safety helmets, bicycles, desk chairs, furniture, keyboards, guitars, any kind of musical instrument, respiratory aids, radiation protection equipment, guns, utility belts, suspenders, ties, dress shirts, undershirts, leotards, tights, ballet shoes, bomber jackets, toe shoes, sports cleats, sports uniforms, sports shoes, golf clubs, baseball bats, footballs, football helmets, football pads, baseball gloves, tennis rackets, sports equipment, sashes, swim suits, bathing suits, bikinis, one-piece bathing suits, diving suits, scuba gear, space suits, special occasion apparel, coffins, hunting apparel, dog collars, cat collars, flea collars, any sort of clothing, apparel, products, shoes, and/or accessories for domesticated animals, GPS locators, alcohol bracelets, hand cuffs, any sort of adult-oriented sexual pleasure apparatus and/or product, clothing, apparel, shoes, and/or accessories, any kind of product, clothing, apparel, shoe, and/or accessory that exists or has yet been discovered, purses, wallets, billfolds, money clips, chains, pocket protectors, cigarette holders, high heels, stiletto heels, Crocs, knee-high boots, garter belts, Uggs, platform shoes, bell-bottoms, dress shirts, business attire, casual attire, flip-flops, harnesses, climbing equipment, Birkenstocks, wraps, aprons, oven mitts, mittens, baby shoes, sleepers, “Onesies,” gowns, baby gowns, diapers, skateboards, surfboards, rain jackets, straps, ponchos, skis, ski jackets, ski pants, motorcycles, jet skis, pool and ocean equipment, intertubes, racing equipment, car equipment, tools, audio equipments, electronic devices, books, and any other sort of line, brand, style, and/or trend of product, clothing, apparel, shoe, and/or accessory that is worn and/or or utilized by an object, person, and/or animal that exists or has yet to be discovered.

As consumers age, develop, gain or lose weight, get taller or shorter, mature, get pregnant, become injured, die, are born, become sedentary, disabled, hospitalized, and/or any other sort of physical or developmental body change, the products, clothing, apparel, shoes, and/or accessories they have already purchased may not fit to their personal and specific body dimensions, sizes, shapes, and trends. The invention will allow for the consumer, business, and/or commercial entity to generate current measurements for means of purchasing new products, clothing, apparel, shoes, and/or accessories. The consumer could have their body scanned for measurements many times over the course of their life to have updated measurements. They may choose to use the invention before holiday shopping or before life events such as weddings, births, and/or any sort of event that can happen in a consumer's life, development, and/or life event. The consumer can choose any time in their life to use the process.

When it comes to differing brands, styles, and trends of products, clothing, apparel, shoes, and/or accessories, items do not all fit the same across all varying types of lines, brands, styles, and trends of products, clothing, apparel, shoes, and/or accessories. The scanner/sensor apparatus can deter this kind of problem for a consumer by having exact measurements that can be accessed for purposes of manufacture. Businesses and/or commercial entities will know the exact specifications by which to manufacture a product, piece of clothing, apparel, shoes, and/or accessory based on the measurements generated by the scanner/sensor apparatus according to the businesses' and/or commercial entities' particular line, brand, style, fit, and trend precedence. Some types of businesses specialize in selling a certain type of product, clothing, apparel, shoe, and/or accessory. The design, materials, technology, size, shape, utility, process, specification, manufacture, implementation, installation, marketing, selling, and/or any other existing and/or yet to be discovered aspect of a scanner/sensor apparatus can be changed and/or modified to suit the needs of a consumer, business, and/or commercial entity.

In regards to licensor royalties, businesses and/or commercial entities will pay for the rights of utilizing the process. The licensor will receive royalties from the businesses and/or commercial entities that sell their varying lines, brands, styles, and trends of products, clothing, apparel, shoes, and/or accessories via the Web-based interface. The licensor will also receive royalties from the advertising dollars generated by businesses and/or commercial entities accessing databases containing consumer measurements and advertising their subsequent abilities to sell and manufacture their products, clothing, apparel, shoes, and/or accessories to a consumer's measurements. The licensor will also receive royalties from businesses and/or commercial entities who implement scanner/sensor apparatuses into their businesses for purposes of utilizing this process.

The operation of this invention/process will now be summarized. A scanner/sensor apparatus and a database and/or memory device are manufactured. The scanner/sensor apparatus, database, and/or memory device are sold to a product, clothing, apparel, shoe, and/or accessory business and/or commercial entity. The scanner/sensor apparatus is implemented and/or installed into a business and/or commercial entity. Consumers have their measurements taken by the scanner/sensor apparatus and the measurements and/or avatars comprised of exact, specific, and/or unique body measurements, physical dispositions, and/or spatial requirements within three dimensional and 360 degree space are stored in a database and/or saved to a memory device.

Businesses and/or commercial entities will upload images of their lines, brands, styles, and trends of products, clothing, apparel, shoes, and/or accessories to a Web-based interface. Consumers then either upload their measurements from a memory device to the Web-based interface or have their measurements stored in a database. Consumers then purchase products, clothing, apparel, shoes, and/or accessories of varying lines, brands, styles, and/or trends via the Web-based interface using “point and click” applications and/or various other applications.

The business and/or commercial entity that the consumer purchases from will access the consumer's measurements on a database system and/or memory device. The business and/or commercial entity then manufactures the particular line, brand, style, and/or trend of product, clothing, apparel, shoes, and/or accessory to the specifications determined by the accessed measurements and/or avatars comprised of exact, specific, and/or unique body measurements, physical dispositions, and/or spatial requirements within three dimensional and 360 degree space and either delivers the product, clothing, apparel, shoes, and/or accessory to the consumer directly or makes it available to the consumer in any ways that exists or yet has been discovered.

If consumers allow businesses and/or commercial entities to access their measurements and/or avatars comprised of exact, specific, and/or unique body measurements, physical dispositions, and/or spatial requirements within three dimensional and 360 degree space, then businesses and/or commercial entities could market and advertise their own particular lines, brands, styles, and/or trends directly to the consumer as well as advertise the ability to sell and manufacture varying lines, brands, styles, and/or trends of products, clothing, apparel, shoes, and/or accessories through various media outlets. The businesses and/or commercial entities will pay to have access to database that will be operated, owned, and/or managed by a particular business and/or commercial entity that the consumer chooses or any other sort of business and/or commercial entity that exists or has yet been discovered.

The use of the invention and/or process allows for businesses to have measurements and/or avatars comprised of exact, specific, and/or unique body measurements, physical dispositions, and/or spatial requirements within three dimensional and 360 degree space of consumers, thus allowing them to sell and manufacture varying lines, brands, styles, and/or trends of products, clothing, apparel, shoes, and/or accessories according to exact, specific, and/or unique body measurements, physical dispositions, and/or spatial requirements of said consumers. This system of “pull” supply chain management will cut down on costs for operating a business and/or commercial entity, make much more efficient use of materials, time, and energy, and provide consumers with a high quality product tailored to their specific measurements, needs, wants, and/or desires. Businesses, commercial entities, and consumers all benefit from the use of the process.

### OPERATION OF INVENTION

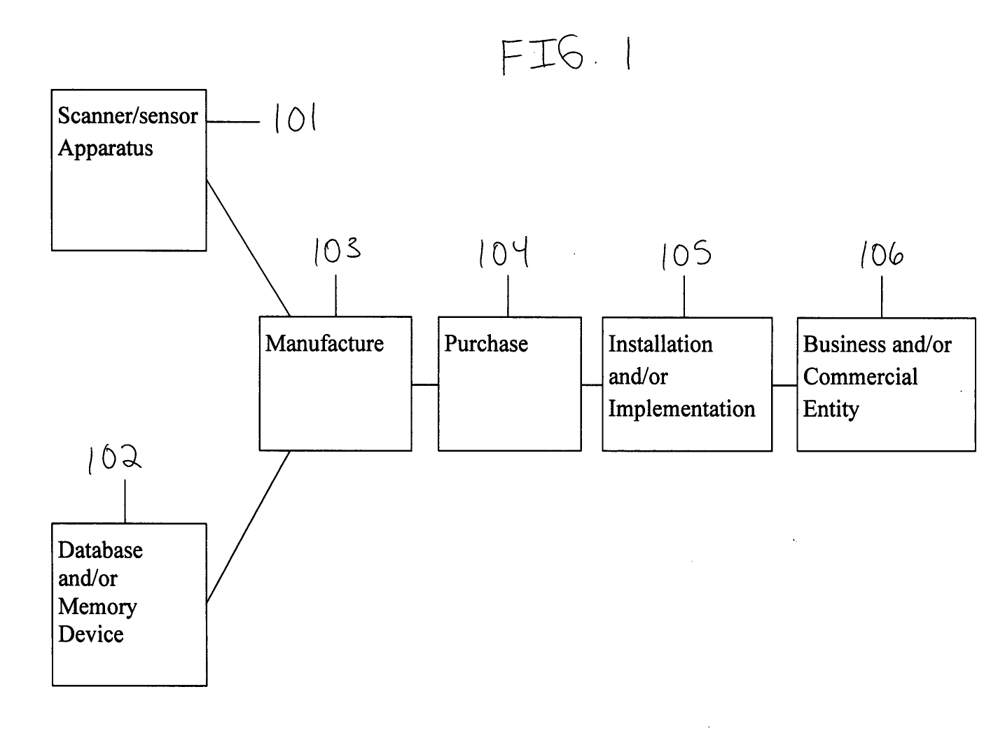

### FIGS. 1, 2, 3, 4, 5, 6, 7, 8, 9, 10, 11, 12, 13, and 14

FIG. 1. This figure is a flowchart of an embodiment of an example of a scanner/sensor apparatus (101), a database system and/or memory device (102), their manufacture (103), their purchase (104), and then their installation and/or implementation (105) into a business and/or commercial entity (106).

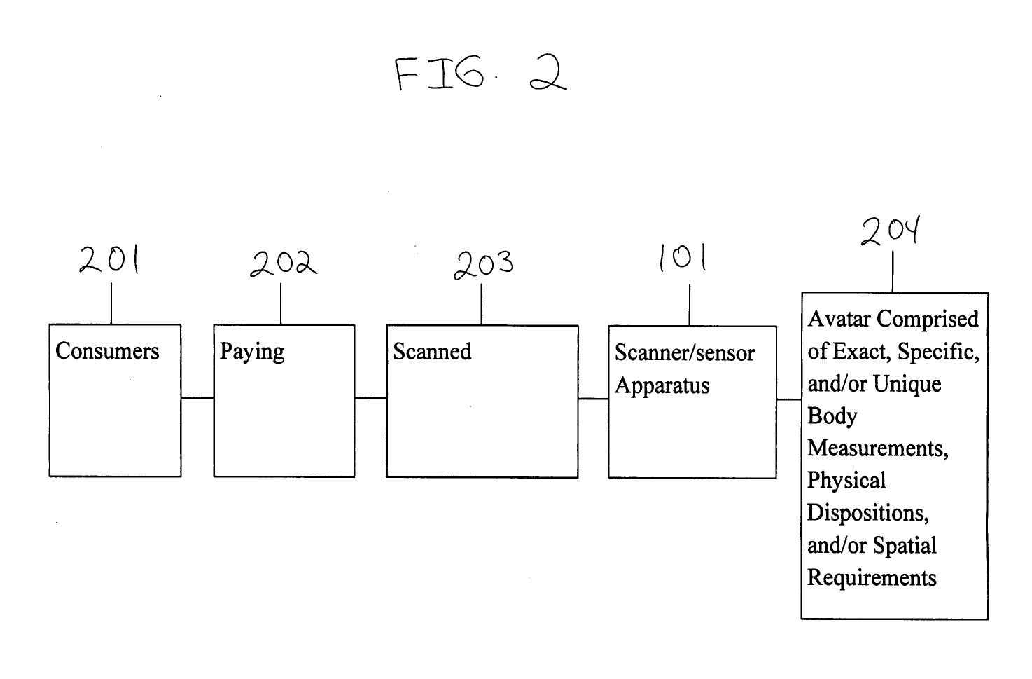

FIG. 2. This figure is a flowchart of an embodiment of an example of consumers (201) paying (202) to have their body dimensions and/or physical dispositions scanned (203) using a scanner/sensor apparatus (101) to generate an avatar comprising their exact, specific, and/or unique body measurements, physical dispositions, and/or spatial requirements scanned within three dimensional and 360 degree space (204).

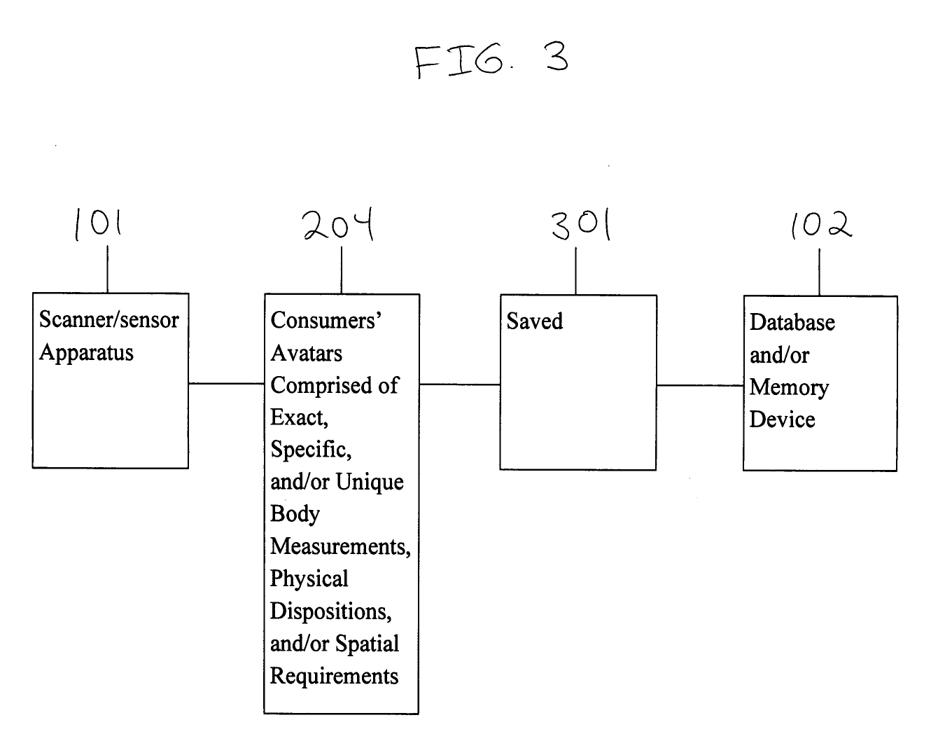

FIG. 3. This figure is a flowchart of an embodiment of an example of consumers' avatars comprised of their exact, specific, and/or unique body measurements, physical dispositions, and/or spatial requirements (204) generated by a scanner/sensor apparatus (101) being saved (301) to a database system and/or memory device (102).

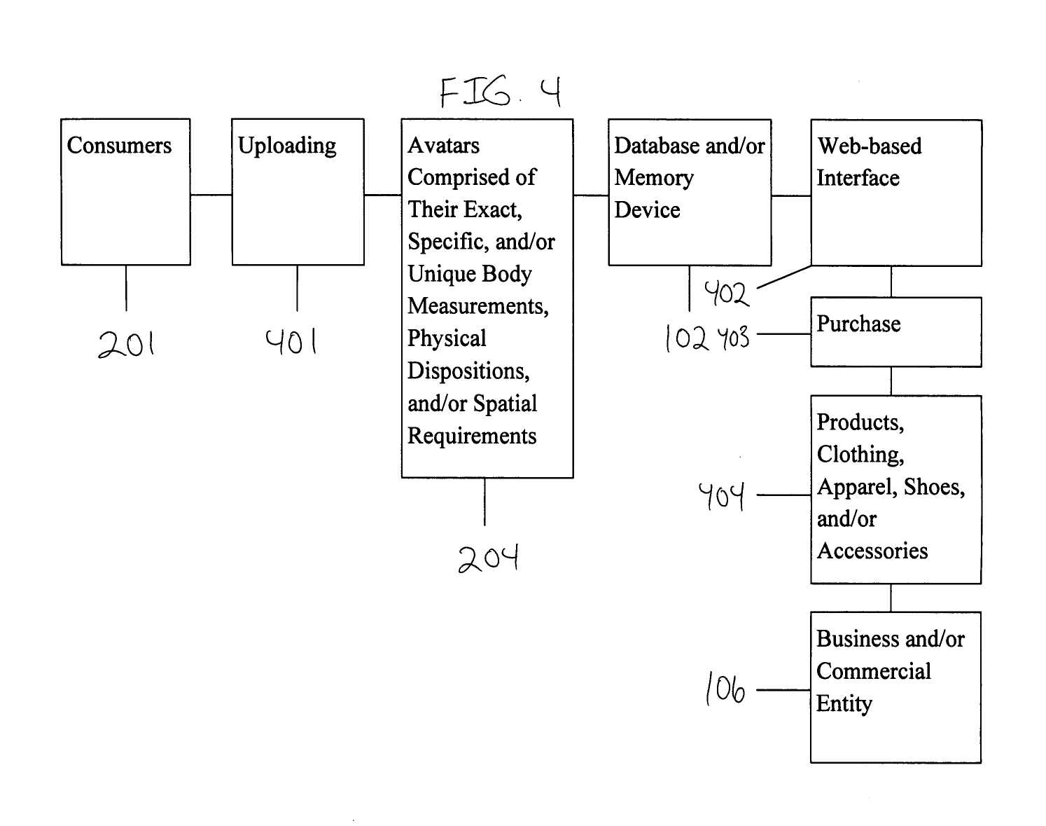

FIG. 4. This figure is a flowchart of an embodiment of an example of consumers (201) uploading (401) avatars comprised of their exact, specific, and/or unique body measurements, physical dispositions, and/or spatial requirements (204) from a database system and/or memory device (102) to a Web-based interface (402) and purchasing (403) products, clothing, apparel, shoes, and/or accessories (404) from a business and/or commercial entity (106) through said Web-based interface.

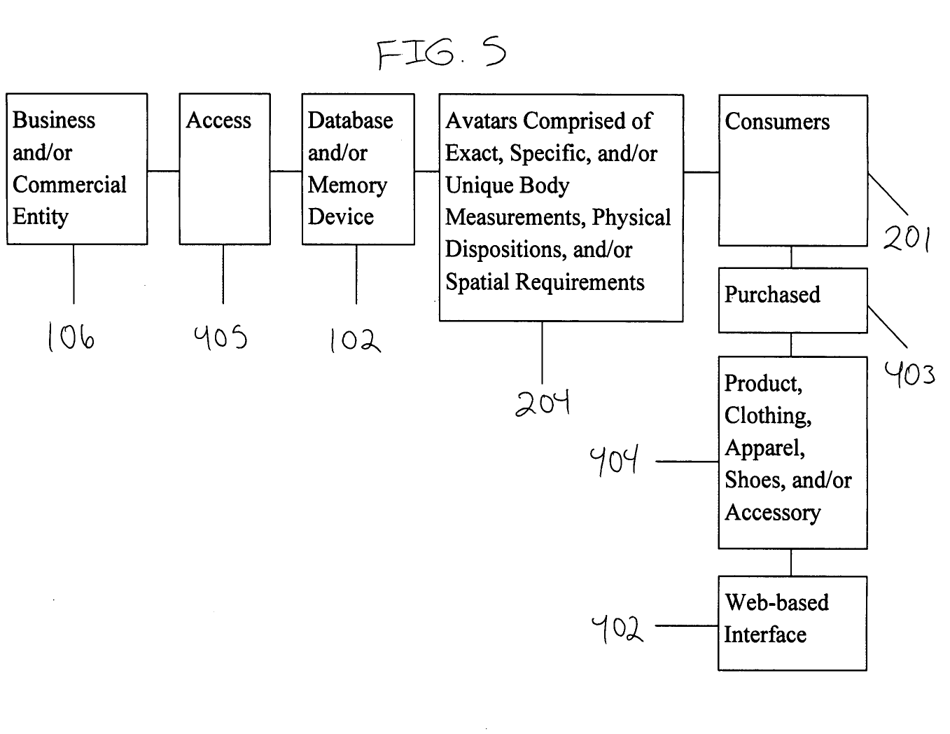

FIG. 5. This figure is a flowchart of an embodiment of an example showing how a business and/or commercial entity (106) could access (405) a database system (102) for consumers' avatars comprised of their exact, specific, and/or unique body measurements, physical dispositions, and/or spatial requirements (204) once consumers (201) have purchased (403) products, clothing, apparel, shoes, and/or accessory (404) via the Web-based interface (402).

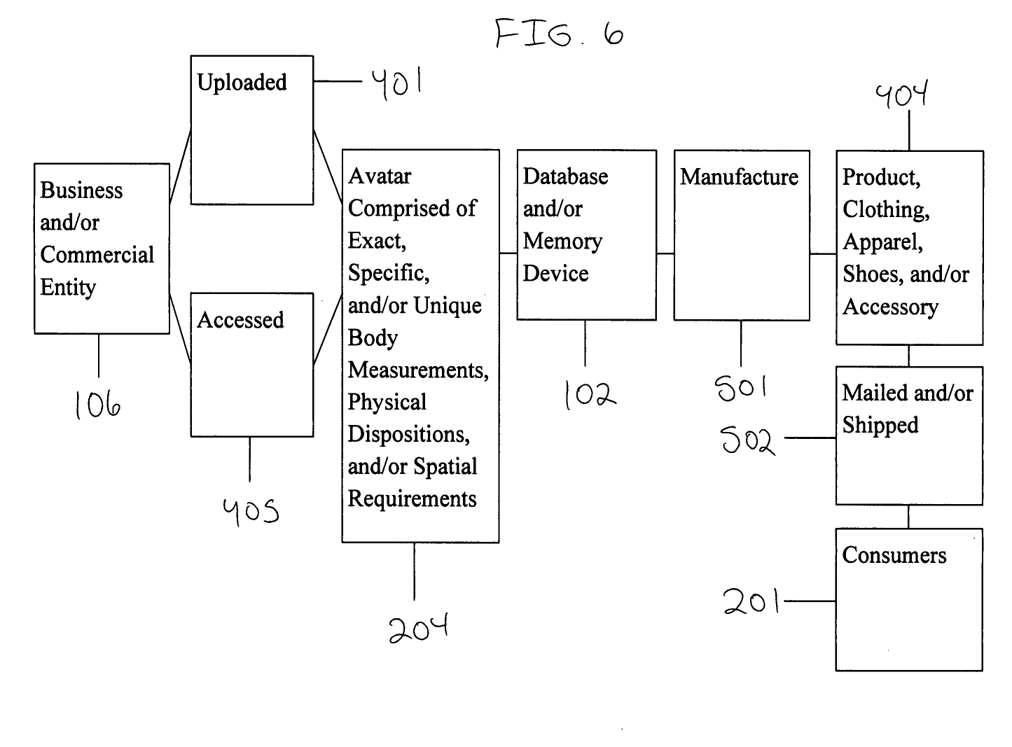

FIG. 6. This figure is a flowchart of an embodiment of an example of a business and/or commercial entity (106) using the uploaded (401) or accessed (405) avatar comprised of exact, specific, and/or unique body measurements, physical dispositions, and/or spatial requirements (204) from a database system or memory device (102) to manufacture (501) products, clothing, apparel, shoes, and/or accessory (404) according to said measurements and consumers (201) being mailed and/or shipped (502) the new product, clothing, apparel, shoes, and/or accessory after purchase and manufacture.

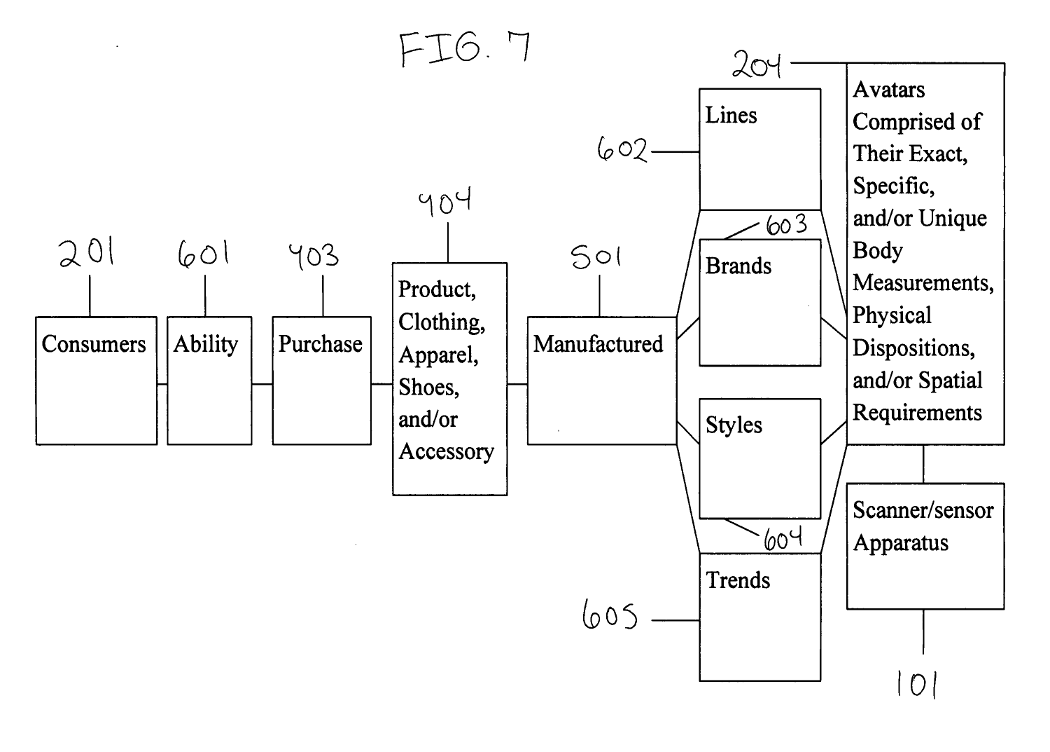

FIG. 7. This figure is a flowchart of an embodiment of an example of consumers' (201) new ability (601) to purchase (403) a product, piece of clothing, piece of apparel, shoes, and/or accessory (404) and have said product, piece of clothing, piece of apparel, shoes, and/or accessory manufactured (501) across existing and yet to be discovered lines (602), brands (603), styles (604), and/or trends (605) according to consumers' avatars comprised of their exact, specific, and/or unique body measurements, physical dispositions, and/or spatial requirements (204) that are generated by the scanner/sensor apparatus (101).

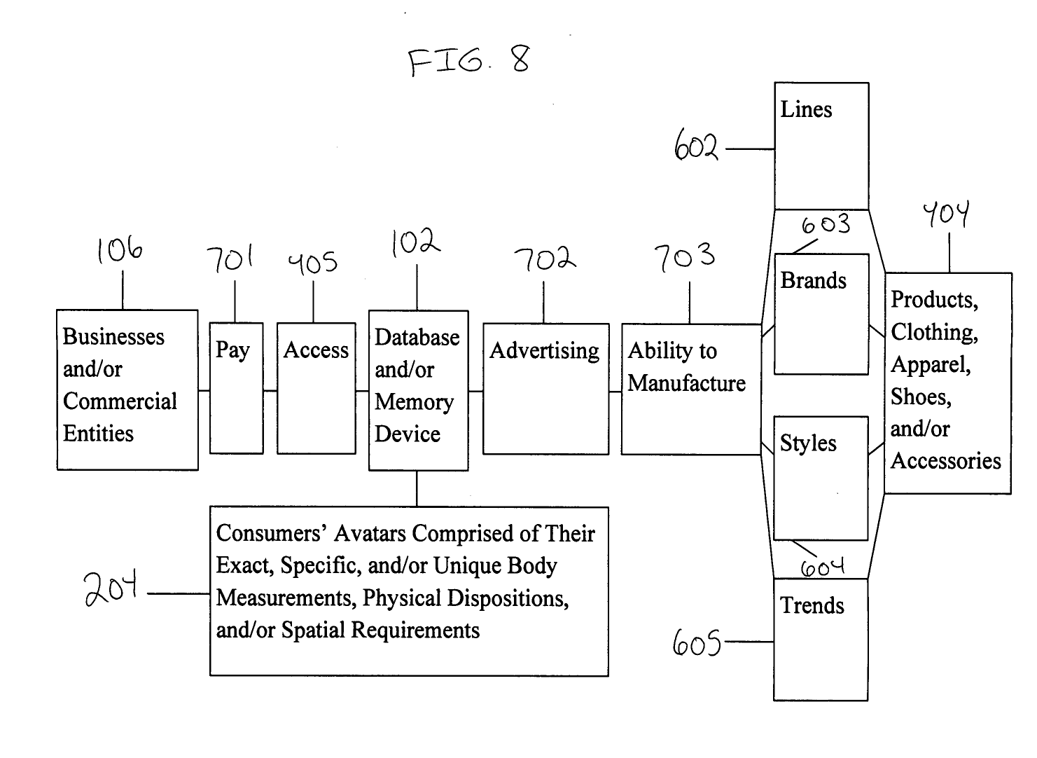

FIG. 8. This figure is a flowchart of an embodiment of an example of how businesses and/or commercial entities (106) can pay (701) to access (405) consumers' avatars comprised of their exact, specific, and/or unique body measurements, physical dispositions, and/or spatial requirements (204) that are stored to a database and/or memory device (102) for purposes of advertising (702) the businesses' and/or commercial entities' ability to manufacture (703) existing and yet to be discovered lines (602), brands (603), styles (604), and trends (605) of said businesses' and/or commercial entities' products, clothing, apparel, shoes, and/or accessories (404) to the exact, specific, and/or unique body measurements, physical dispositions, and/or spatial requirements of consumers generated by the scanner/sensor apparatus.

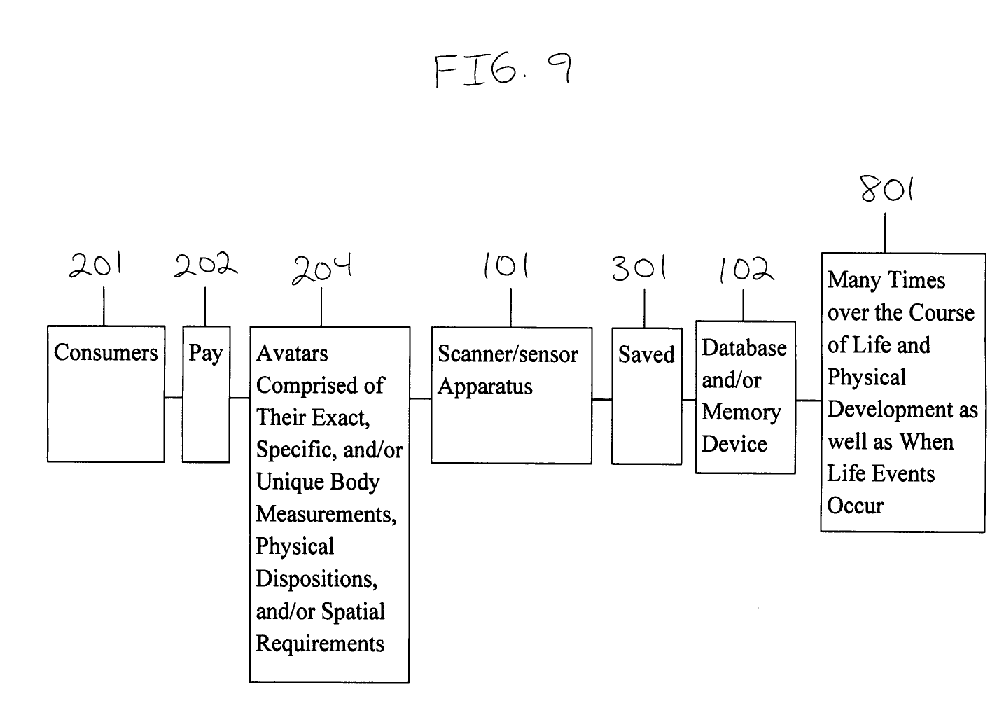

FIG. 9. This figure is a flowchart of an embodiment of an example of how consumers (201) can pay (202) to have their avatars comprised of their exact, specific, and/or unique body measurements, physical dispositions, and/or spatial requirements (204) generated by a scanner/sensor apparatus (101) and saved (301) to a database system and/or memory device (102) many times over the course of their life and physical development as well as when life events occur (801) for purposes of purchasing varying lines, brands, styles, and/or trends of products, clothing, apparel, shoes, and/or accessories.

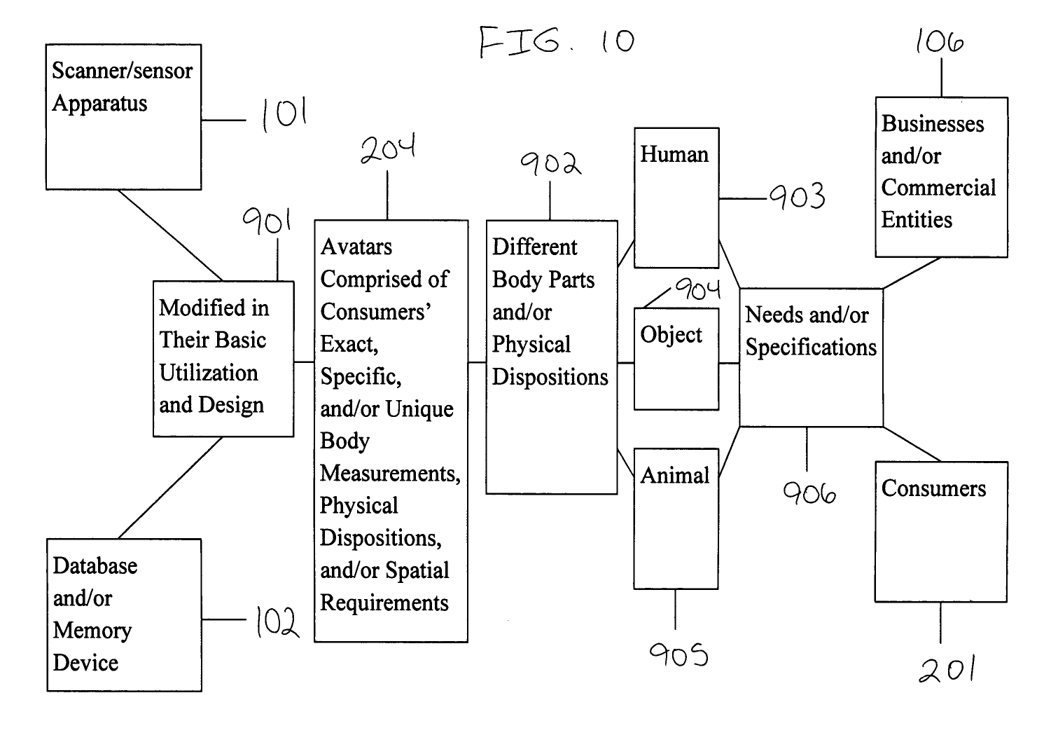

FIG. 10. This figure is a flowchart of an embodiment of an example of how the scanner/sensor apparatus (101) and database system and/or memory device (102) can be modified in their basic utilization and design (901) to generate avatars comprised of consumers' exact, specific, and/or unique body measurements, physical dispositions, and/or spatial requirements (204) for different body parts and/or physical dispositions (902) of a human (903), object (904), and/or animal (905) according to the needs and/or specializations (906) of businesses and/or commercial entities (106) and consumers (201).

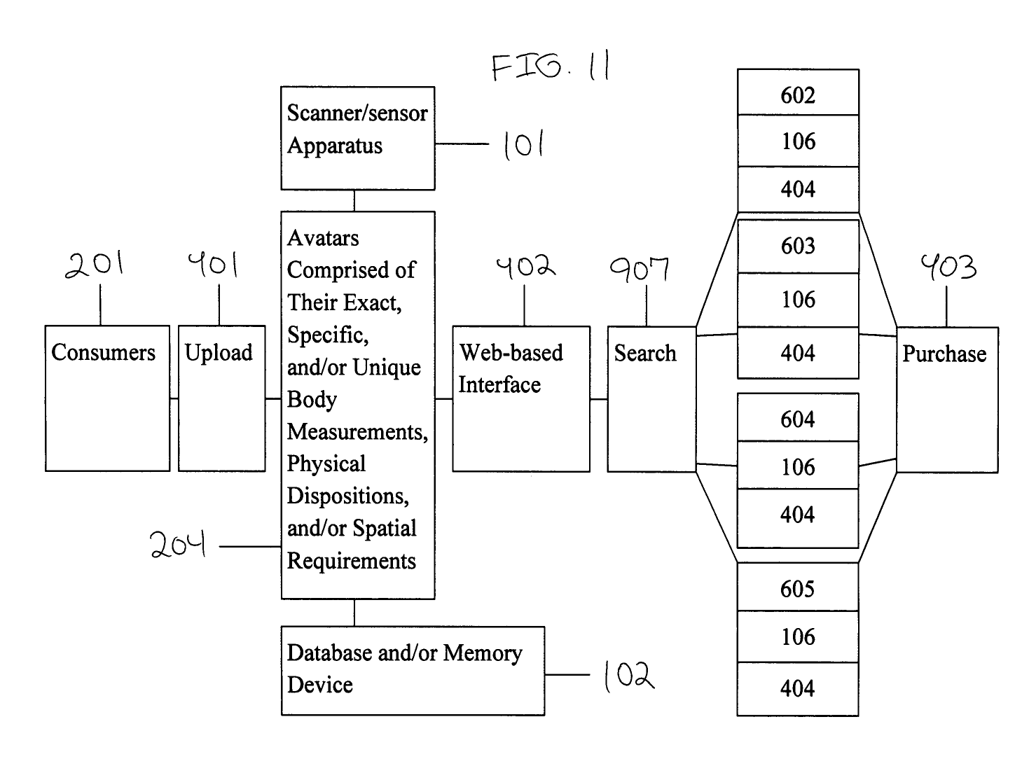

FIG. 11. This figure is a flowchart depicting an embodiment of an example of how consumers will be able to utilize a Web-based interface to purchase products, clothing, apparel, shoes, and/or accessories from all existing or yet to be discovered businesses and/or commercial entities. The figure shows how consumers (201) will upload (401) avatars comprised of their exact, specific, and/or unique body measurements, physical dispositions, and/or spatial requirements (204) generated by a scanner/sensor apparatus (101) from a memory device (102) to a Web-based interface (402) and then search (907) said Web-based interface for varying lines (602), brands (603), styles (604), and trends (605) of businesses' and/or commercial entities' (106) products, clothing, apparel, shoes, and/or accessories (404) and make a purchase (403).

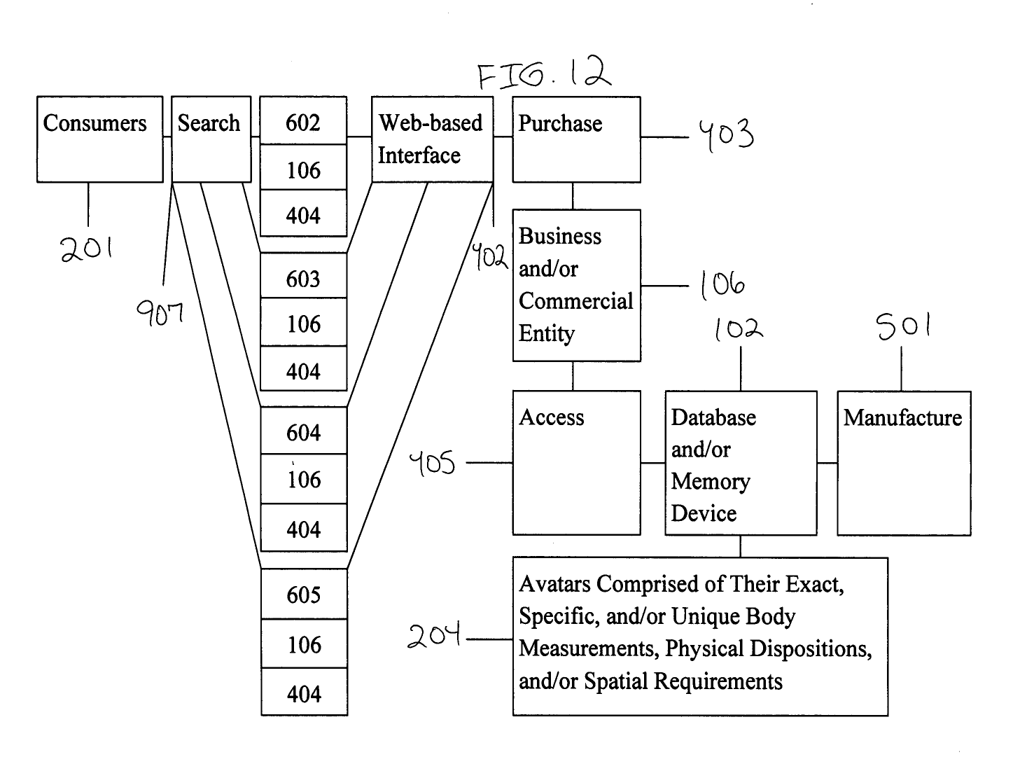

FIG. 12. This figure is a flowchart of an embodiment of an example of how consumers (201) will search (907) for varying lines (602), brands (603), styles (604), and trends (605) of businesses' and/or commercial entities' (106) products, clothing, apparel, shoes, and/or accessories (404) via a Web-based interface (402) and make purchases (403). A business and/or commercial entity (106) that had been purchased from will then access (405) a database system (102) that contains consumers' avatars comprised of their exact, specific, and/or unique body measurements, physical dispositions, and/or spatial requirements (204) for means of manufacturing (501) the purchased product, clothing, apparel, shoes, and/or accessory.

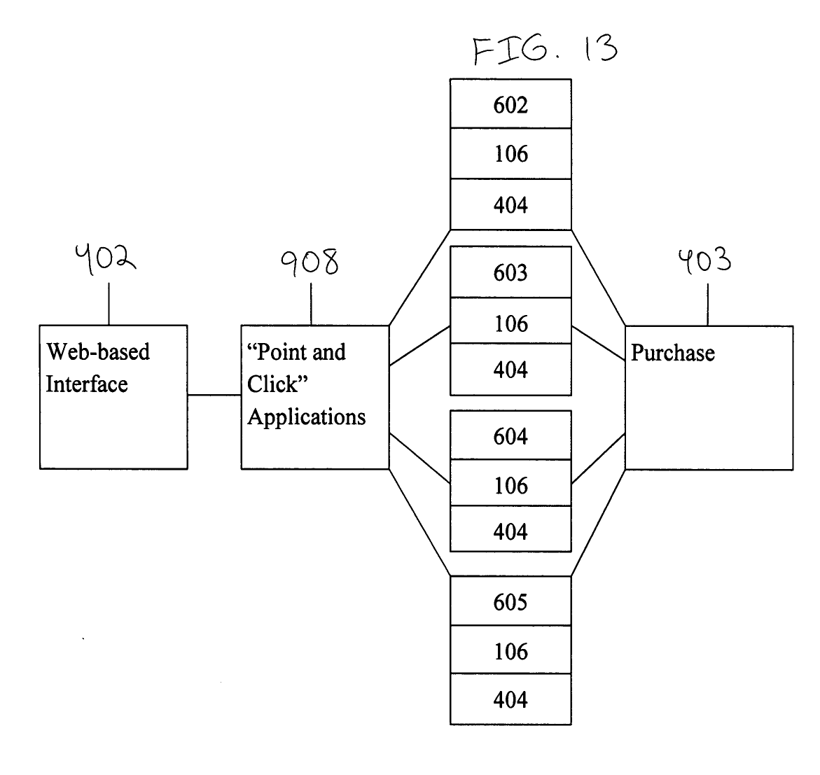

FIG. 13. This figure is a flowchart of an embodiment of an example of how a Web-based interface (402) will contain “point and click” applications (908) that allow consumers to pick and choose between all existing and yet to be discovered lines (602), brands (603), styles (604), and trends (605) of businesses' and/or commercial entities' (106) products, clothing, apparel, shoes, and/or accessories (404) and make purchases (403).

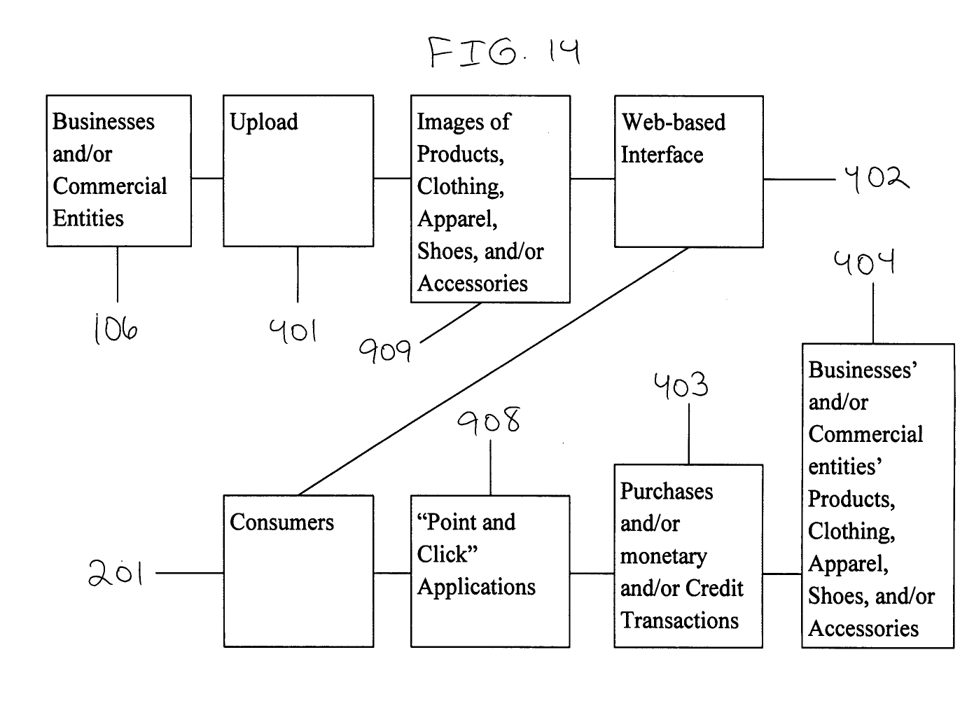

FIG. 14. This figure is a flowchart of an embodiment of an example of businesses and/or commercial entities (106) uploading (401) images of the products, clothing, apparel, shoes, and/or accessories (909) that are sold and manufactured by said businesses and/or commercial entities to a Web-based interface (402). Businesses and/or commercial entities (106) will upload (401) the images (909) to a Web-based interface (402) and consumers (201) will be able to use “point and click” applications (908) within the Web-based interface that will link them to the uploaded images and allow the consumer to conduct purchases and/or monetary and/or credit transactions (403) for said businesses' and/or commercial entities' products, clothing, apparel, shoes, and/or accessories (404).

### CONCLUSION, RAMIFICATIONS, AND SCOPE OF THE INVENTION

While my above description contains many specificities, these should not be construed as limitations on the scope of the invention, but rather as an exemplification of one preferred embodiment thereof. Some variations could be possible. There are many different kinds of products, clothing, apparel, shoes, and/or accessories that can be manufactured to the exact, specific, and/or unique body measurements, physical dispositions, and/or spatial requirements of a consumer. There are many different lines, brands, styles, and/or trends of products, clothing, apparel, shoes, and/or accessories that can be manufactured to the exact, specific, and/or unique body measurements, physical dispositions, and/or spatial requirements. There are many different kinds of scanner/sensor technologies that exist or have yet to be discovered that could be used for purposes of scanning a consumer's exact, specific, and/or unique body measurements, physical dispositions, and/or spatial requirements in three dimensional and 360 degree space. There are many types of supply chain management systems that could be utilized in a process such as in this invention. There are many ways to manufacture a database system and/or memory device and said database systems and/or memory devices can have many different applications, processes, technologies, utilizations, and access functions. There are many types of Web-based interfaces and many existing or yet to be discovered interfaces written in any type of language or structured within any kind of functionality. There are many ways to make purchases on Web-based interfaces and many ways to complete applications rather than just “Point and Click” applications. There are many ways that consumers' measurements and/or avatars comprised of exact, specific, and/or unique body measurements, physical dispositions, and/or spatial requirements within three dimensional and 360 degree space can be used for purposes of advertising. There are many ways that the advertising and marketing of businesses' and/or commercial entities' ability to sell and manufacture varying lines, brands, styles, and/or trend of products, clothing, apparel, shoes, and/or accessories across varying mediums of communication and marketing. There are many ways to facilitate credit and/or monetary transactions using Web-based interfaces. The uploading of images of products, clothing, apparel, shoes, and/or accessories to Web-based interfaces can be conducted in a myriad of ways. The uploading of consumers' measurements and/or avatars comprised of exact, specific, and/or unique body measurements, physical dispositions, and/or spatial requirements within three dimensional and 360 degree space from database systems and/or memory devices to Web-based interfaces and various businesses and/or commercial entities can occur in many different ways using electronic transmission of data. There are many ways to access database systems and/or memory devices for purposes of retrieving data in the form of consumers' measurements and/or avatars comprised of exact, specific, and/or unique body measurements, physical dispositions, and/or spatial requirements within three dimensional and 360 degree space.

I claim:

1. A process for integrating scanner/sensor apparatuses, Web-based interfaces, and pull-supply chain into product, clothing, apparel, shoe, and/or accessory markets that comprises:
Manufacturing scanner/sensor apparatuses and databases and/or memory devices;
Purchasing, installing, and implementing by businesses and/or commercial entities of scanner/sensor apparatuses and databases and/or memory devices into businesses and/or commercial sites;
Creating a Web-based interface that contains applications that allow consumers to make purchases of varying lines, brands, styles, and/or trends of products, clothing, apparel, shoes, and/or accessories;
Paying by consumers to have their measurements and/or avatars comprised of exact, specific, and/or unique body measurements, physical dispositions, and/or spatial requirements within three dimensional and 360 degree space generated by the scanner/sensor apparatuses at business and/or commercial sites;
Saving the generated consumers' generated measurements and/or avatars to a database and/or memory device;
Uploading and/or accessing the consumers' generated measurements and/or avatars from a database and/or memory device to a Web-based interface;
Uploading of images of businesses' and/or commercial entities' varying lines, brands, styles, and/or trends of products, clothing, apparel, shoes, and/or accessories to a Web-based interface;
Purchasing by consumers of varying lines, brands, styles, and/or trends of products, clothing, apparel, shoes, and/or accessories through a Web-based interface using secure monetary and/or credit transactions;
Accessing of databases and/or memory devices by manufacturers, businesses, and/or commercial entities that contain consumers' measurements and/or avatars comprised of exact, specific, and/or unique body measurements, physical dispositions, and/or spatial requirements within three dimensional and 360 degree space after a purchase of a line, brand, style, and/or trend of products, clothing, apparel, shoes, and/or accessories;
Manufacturing of purchased lines, brands, styles, and/or trends of products, clothing, apparel, shoes, and/or accessories according to consumers' measurements and/or avatars comprised of exact, specific, and/or unique body measurements, physical dispositions, and/or spatial requirements within three dimensional and 360 degree space;
Paying for and accessing of databases and/or memory devices by manufacturers, businesses, and/or commercial entities that contain consumers' measurements and/or avatars comprised of exact, specific, and/or unique body measurements, physical dispositions, and/or spatial requirements within three dimensional and 360 degree space for purposes of advertising the ability to manufacture and sell a line, brand, style, and/or trend of products, clothing, apparel, shoes, and/or accessories;
Modifying of scanner/sensor apparatuses in their design and utilization according to the needs and/or specialization of consumers, businesses, and/or commercial entities;
Shipping of newly manufactured and purchased lines, brands, styles, and/or trends of products, clothing, apparel, shoes, and/or accessories to consumers;

2. A process in claim 1 wherein a consumer, person, object, or animal will have exact, specific, and/or unique body measurements, physical dispositions, and/or spatial requirements within three dimensional and 360 degree space generated by a scanner/sensor apparatus.

3. A process in claim 1 wherein the generated measurements are saved to a database and/or memory device as an avatar and/or file comprised of the consumer's, person's, object's, or animal's exact, specific, and/or unique body measurements, physical dispositions, and/or spatial requirements within three dimensional and 360 degree space.

4. A process in claim 1 wherein a business, commercial entity, consumer, person, object, or animal will upload the avatar and/or file comprised of the consumer's, person's, object's, or animal's exact, specific, and/or unique body measurements, physical dispositions, and/or spatial requirements within three dimensional and 360 degree space to a Web-based interface.

5. A process in claim 1 wherein a business and/or commercial entity will upload digital files and/or pictures of their lines, brands, styles, and/or trends of products, clothing, apparel, shoes, and/or accessories to a Web-based interface.

6. A process in claim 1 wherein a Web-based interface will have applications that allow for a consumer, person, object, or animal to purchase lines, brands, styles, and/or trends of products, clothing, apparel, shoes, and/or accessories that have been uploaded by a business and/or commercial entity.

7. A process in claim 6 wherein a consumer, person, object, or animal will be able to facilitate secure monetary and/or credit transactions related to purchases of lines, brands, styles, and/or trends of products, clothing, apparel, shoes, and/or accessories using applications within a Web-based interface.

8. A process in claim 1 wherein once a consumer, person, object, or animal has made a purchase, the business and/or commercial entity will access a database and/or memory device where said consumer, person, object, or animal has their the avatar and/or file comprised of the consumer's, person's, object's, or animal's exact, specific, and/or unique body measurements, physical dispositions, and/or spatial requirements within three dimensional and 360 degree space.

9. A process in claim 8 wherein a business and/or commercial entity will sell and/or manufacture the purchased product, clothing, apparel, shoes, and/or accessory according to the consumer's, person's, object's, or animal's exact, specific, and/or unique body measurements, physical dispositions, and/or spatial requirements within three dimensional and 360 degree space.

10. A process in claim 1 wherein upon the completion of selling and/or manufacturing of a purchased product, clothing, apparel, shoes, and/or accessory the business and/or commercial entity will ship said product, clothing, apparel, shoes, and/or accessory to the consumer and/or a desired location.

11. A process in claim 1 wherein a consumer, person, object, or animal will be able to purchase across the spectrum of varying lines, brands, styles, and/or trends of products, clothing, apparel, shoes, and/or accessories and have said products, clothing, apparel, shoes, and/or accessories manufactured to fit the exact, specific, and/or unique body measurements, physical dispositions, and/or spatial requirements within three dimensional and 360 degree space of said consumer, person, object, or animal.

12. A process in claim 1 wherein a business and/or commercial entity will pay owners of a database and/or memory device that has a consumer's, person's, object's, or animal's saved exact, specific, and/or unique body measurements, physical dispositions, and/or spatial requirements within three dimensional and 360 degree space as an avatar and/or file.

13. A process in claim 12 wherein once a business and/or commercial entity has paid to access a database and/or memory device containing a consumer's, person's, object's, or animal's saved exact, specific, and/or unique body measurements, physical dispositions, and/or spatial requirements within three dimensional and 360 degree space as an avatar and/or file that said business and/or commercial entity will be able to advertise the ability to manufacture and sell lines, brands, styles, and/or trends of products, clothing, apparel, shoes, and/or accessories according to said consumer's, person's, object's, or animal's exact, specific, and/or unique body measurements, physical dispositions, and/or spatial requirements within three dimensional and 360 degree space.

14. A process in claim 1 wherein a scanner/sensor apparatus can be modified in terms of design and utility to generate an avatar and/or file comprised of exact, specific, and/or unique body measurements, physical dispositions, and/or spatial requirements within three dimensional and 360 degree space for different parts of a consumer's, person's, object's, or animal's body, physical disposition, and/or spatial requirement.

15. A process in claim 1 where in a consumer, person, object, or animal will have exact, specific, and/or unique body measurements, physical dispositions, and/or spatial requirements within three dimensional and 360 degree space generated by a scanner/sensor apparatus many times over the course of development, maturity, and life and/or as life events occur.

16. A process in claim 1 wherein the licensor of the invention will be paid royalties associated with the generation of an avatar and/or file comprised of exact, specific, and/or unique body measurements, physical dispositions, and/or spatial requirements within three dimensional and 360 degree space as well as the selling and manufacturing of lines, brands, styles, and/or trends of products, clothing, apparel, shoes, and/or accessories and any advertising associated with the use of the invention.

17. A process in claim 1 wherein any type of existing or yet to be discovered line, brand, style, and/or trend of product, clothing, apparel, shoes, and/or accessory that a consumer, person, object, or animal wears and/or utilizes on the body, physical disposition, and/or spatial displacement can be manufactured and sold after an avatar and/or file comprised of exact, specific, and/or unique body measurements, physical dispositions, and/or spatial requirements within three dimensional and 360 degree space has been generated by a scanner/sensor apparatus.

18. A process in claim 1 wherein any type of existing or yet to be discovered line, brand, style, and/or trend of product, clothing, apparel, shoes, and/or accessory that a consumer, person, object, or animal wears and/or utilizes on the body, physical disposition, and/or spatial displacement can be uploaded as a digital file and/or picture to a Web-based interface and sold to a consumer, person, object, or animal that has uploaded an avatar and/or file comprised of exact, specific, and/or unique body measurements, physical dispositions, and/or spatial requirements within three dimensional and 360 degree space to said interface and requires the product, clothing, apparel, shoes, and/or accessory be manufactured to said exact, specific, and/or unique measurements, dispositions, and/or requirements.

19. A process in claim 1 wherein any type of existing or yet to be discovered line, brand, style, and/or trend of product, clothing, apparel, shoes, and/or accessory that a consumer, person, object, or animal wears and/or utilizes on the body, physical disposition, and/or spatial displacement can be advertised to a consumer, person, object, or animal once a business and/or commercial entity has paid for access to a database and/or memory device containing said consumer's, person's, objects, or animal's avatar and/or file comprised of exact, specific, and/or unique body measurements, physical dispositions, and/or spatial requirements within three dimensional and 360 degree space.

20. A process in claim 1 wherein a business and/or commercial entity will be able to utilize a consumer's, person's, object's, or animal's avatar and/or file comprised of exact, specific, and/or unique body measurements, physical dispositions, and/or spatial requirements within three dimensional and 360 degree space to advertise said business' and/or commercial entities' ability to sell and manufacture varying lines, brands, styles, and/or trends of products, clothing, apparel, shoes, and/or accessories.
